(19) United States
(12) Patent Application Publication
(10) Pub. No.: US 2026/0147202 A1
(43) Pub. Date: May 28, 2026

(54) OPTICAL DEVICE FOR MANIPULATING AN ATOM OR AN OBJECT

(71) Applicant: Rheinland-Pfälzische Technische Universität Kaiserlautern-Landau, Körperschaft des öffentlichen Rech, Kaiserlautern (DE)

(72) Inventors: Artur Widera, Kaiserlautern (DE); Herwig Ott, Kaiserlautern (DE); Thomas Niederprüm, Kaiserlautern (DE)

(73) Assignee: Rheinland-Pfälzische Technische Universität Kaiserlautern-Landau, Körperschaft des öffentlichen Rech, Kaiserlautern (DE)

(21) Appl. No.: 19/371,969

(22) Filed: Oct. 28, 2025

(30) Foreign Application Priority Data
Oct. 31, 2024 (DE) 102024131876.7

(51) Int. Cl. G02B 26/08; G06N 10/40; G21K 1/30

(52) U.S. Cl. CPC G02B 26/0833; G06N 10/40; G21K 1/30; G21K 2201/06

(57) ABSTRACT

An optical device for manipulating an atom or an object comprises a light source for emitting a short-wave electromagnetic beam; and a movable optical element for influencing the beam wherein the optical element has 3D mobility; the beam of the light source is directed to the optical element and is focused at a focal point in the beam path thereafter; wherein the optical element is arranged and configured such that by the movement of the optical element the focal point is displaceable and a spatial manipulation of the atom or object is caused in an environment around the focal point.

### CROSS-REFERENCE TO RELATED APPLICATION(S)

This application claims priority to German Patent Application No. 10 2024 131 876.7, filed Oct. 31, 2024, the contents of which is hereby incorporated by reference in its entirety.

### BACKGROUND

The present invention relates to an optical device for manipulating an atom or an object with a light source that emits a short-wave electromagnetic beam, and with a movable optical element for influencing the beam.

Such devices are also known as optical tweezers, with which atoms or particles, i.e., objects, or molecules can be influenced. The influencing or manipulation relates, for example, to holding or moving the atom in a direction transverse to the beam. Optical tweezers are strongly focused laser beams with a typical focus diameter of at least 0.1 μm and larger. They have been used for many years, for example to manipulate matter.

With previous technologies, optical tweezers can usually only be moved in two spatial directions perpendicular to the beam direction. For this purpose, for example, tiltable mirrors are used, as described in Stuart & Kuhn, New J. Phys. 20023013(2018 ) (https://doi.org/10.1088/1367-2630/aaa634), or acousto-optical modulators and deflectors, as known from Barredo et al., Science 354, 1021-1023 (2016) (https://doi.org/10.1126/science.aah3778) or Endres et al., Science 354, 1024-1027 (2016) (https://doi.org/10.1126/science.aah3752). Likewise, according to Dumke et al., Phys. Rev. Lett. 89, 097903 (2002), microlens arrays or according to Nogrette et al., PRX 4, 021034 (2014) (https://doi.org/10.1103/PhysRevX.4.021034) so-called phase spatial light modulators can be used. While the latter methods also allow static three-dimensional tweezer arrangements (Schlosser et al., Phys. Rev. Lett. 130, 180601(2023 ) (https://doi.org/10.1103/PhysRevLett.130.180601) and Barredo et al., Nature 561, 79 (2018) (https://doi.org/10.1038/s41586-018-0450-2)), movement in three dimensions is only possible due to an additional optical element that shifts the focus. For this purpose, mechanical translation stages, electrically deformable mirrors according to Huang et al., Rev. Sci. Instrum. 80, 063107 (2009) (https://doi.org/10.1063/1.3156838), or lenses with adjustable focal length (“tunable lenses”) according to Iwai et al., Scientific Reports, 9, 12365 (2019) (https://doi.org/10.1038), can be used. However, these approaches have decisive disadvantages:
1. Two different optical elements are required that must be precisely aligned with each other. The bandwidth is limited to less than 1 kHz according to Iwai et al. The mechanical displacement of the focusing lens is limited to a few Hz bandwidth due to the high moving mass, as is moving the sample holder.
2. An extension to more than one optical tweezer requires the multiplication of the optical setups and a subsequent superposition of all optical tweezers by means of complex and alignment-intensive optics.
3. Holographic methods (“Phase SLMs”) require complex calculations to compute the necessary phase pattern. These calculations cannot be performed fast enough to enable rapid movement of the tweezers.

The state of the art does not offer a possibility to move optical tweezers at high speed in three dimensions to rapidly move single or multiple atoms and bring them to a desired position. In this context rapidly means with a bandwidth of more than 1 kHz or a “travel speed” at which the distance to be covered is traversed within less than two milliseconds. When multiple optical tweezers have to be generated and moved rapidly, this is only realizable one-dimensionally (1D) or two-dimensionally (2D) according to the current state of the art, but not three-dimensionally (3D).

There is thus a great need to propose an optical tweezer that allows rapid and precise movement in three dimensions with only one optical element. Furthermore, there is a need to move several such optical tweezers independently of each other and preferably also simultaneously.

### SUMMARY OF THE INVENTION

The present object is solved by an optical device for manipulating an atom or an object. Furthermore, the object is solved by an optical tweezer and by a system.

In one aspect, the present invention relates to an optical device for manipulating an atom or an object with a light source for emitting a short-wave electromagnetic beam and with a movable optical element for influencing the beam. The optical element has three-dimensional mobility (3D mobility). The beam of the light source is directed to the optical element and focused in a focal point in the beam path thereafter. The optical device is correspondingly constructed and configured. The optical element is arranged and configured such that by the movement of the optical element the focal point is displaceable and a spatial manipulation of the atom or object is caused in an environment around the focal point. Here, a three-dimensional movement or manipulation is enabled that also allows movement in the beam direction.

In a further aspect, the present invention relates to an optical tweezer that is constructed according to the device just described. The optical tweezers are based on a device as described above and thus enable execution of the movement of the focal point. They thus enable manipulation of an object or atom or multiple atoms in three spatial directions, including a direction in the beam direction.

Further aspects of the invention relate to a corresponding method and a computer program product with a program code for performing the steps of the method when the program code is executed on a computer, as well as a storage medium on which a computer program is stored that, when executed on a computer, causes execution of the method described herein.

Preferred embodiments of the invention are described in the dependent claims. It is understood that the features mentioned above and those to be explained below can be used not only in the respectively indicated combination, but also in other combinations or alone, without departing from the scope of the present invention. In particular, the method and the computer program product can be implemented according to the embodiments described for the device in the dependent claims.

The invention is based on the idea of introducing a miniaturized optical element, such as a mirror or micromirror, into a laser beam. The laser beam is preferably convergent or divergent. The optical element (microelement) has 3D mobility, i.e., is movable in three spatial dimensions or directions. Here, the optical element can be moved translationally, for example, and additionally tilted in at least two spatial directions. While the tilting movements are responsible for enabling an object or atom arranged in the laser focus or focal point or an object or atom arranged near the focal point to be moved and manipulated perpendicular to the beam direction, the translational movement of the optical element causes a displacement in and against the beam direction. The beam direction is the direction of the laser beam in the beam path.

Due to the translational and transverse movements of the optical element possible in addition to the rotational movements, manipulation directions on the atom or object can also be realized in the translational or transverse direction. It is advantageous here that only one optical element has to be used. However, it has to be movable in three spatial directions.

For example, three-dimensional mobility can be achieved through support points of the micro-optical or optical element. Thus, both translational and tilting movements of the element can be achieved.

The term 3D mobility of the optical element is understood to mean mobility in three spatial dimensions or spatial directions, wherein the mobility in the spatial directions can occur independently of each other and in multiple spatial directions simultaneously or temporally offset.

Thus, the invention can preferably be used in quantum computers, where the use of atom arrays plays an increasingly important role. This is particularly the case in the realization of multiple “parallel” (but independently operating) optical devices according to the invention (so-called optical tweezers).

In a preferred embodiment, an objective lens is arranged in the beam path between the optical element and the focal point. Due to the use of the objective lens the beam of the light source can be focused at the focal point. Additionally or alternatively, a lens can be arranged in the beam path between the light source and the optical element. Preferably, the lens is used to change the beam path of the light source such that preferably a focus of the light beam is generated in front of the optical element. The optical element itself preferably lies outside a first focus in the beam path of the beam of the light source.

A preferred embodiment provides that the generated focal point lies within a spatial extent of the atom or the object. The object or the atom is thus arranged such that the focal point of the beam of the light source generated by the light source and the device lies within the object. In other words, the beam is aligned and directed such that its focal point is formed at or near the location of the atom or object. In this way, the object or the atom can be very effectively influenced such that a force or impulse is exerted on the object or atom by the light beam. In this way, the object or atom can be manipulated or moved, held in its position, or shifted in its position.

A preferred embodiment of the device provides that the light source is a laser or a laser light source. The light source emits short-wave electromagnetic radiation; this light beam or beam is a laser beam. Particularly preferably, the generated laser beam has a wavelength between 200 nanometers and 11 micrometers. Very preferably, the wavelength of the laser beam is between 270 nanometers and 500 nanometers and also very preferably between 900 nanometers and 1100 nanometers.

A preferred embodiment provides that the 3D mobility of the optical element is given in all spatial directions. Preferably, the 3D mobility in all spatial directions is given such that the atom or object is movable in all spatial directions. Particularly preferably, it is provided that mobility is enabled at least in the beam direction of the beam. Movement in individual spatial directions can preferably occur separately and independently of each other. It is thus possible to perform a movement of the focal point in the X-direction or a movement in the Y-direction or in the Z-direction in the space spanned by XYZ coordinates or to cause such a movement of the atom or object. The individual movements can occur simultaneously or temporally one after another. They can occur without a movement in one of the other spatial directions taking place or being influenced. They can also occur together so that any direction in space can be generated.

In a further preferred embodiment, a beam or laser beam is generated by the light source that is—at least partially or sectionally—divergent or convergent. The laser beam is thus—at least partially or sectionally—focused or defocused, preferably at the location of the optical element. Such a laser beam can be generated, for example, by the optional objective lens or the lens between the light source and optical element. Here it is important that the optical element is not arranged at a focal point of the laser beam. The laser beam is thus defocused at the location of the optical element. It can be divergent or preferably convergent. The laser beam is also divergent or convergent at the focal point, i.e., at the location where the atom or object is arranged. This is preferably caused by the objective lens. The laser beam is thus focused at the location where the atom or object are arranged.

Preferably, the optical element is arranged in a region in the beam path where the beam is divergent or convergent. The optical element is thus located in a defocused region of the beam, consequently outside a focus.

In an also preferred embodiment of the device, the optical element is a mirror. The mirror can be, for example and preferably, a MEMS mirror. These mirrors can be controlled or moved particularly rapidly and precisely so that their spatial position can be changed rapidly and easily. For example, MEMS mirrors are electrically controlled so that the electrical signals can be quickly transmitted to the mirror and the desired effect can be produced.

In a preferred embodiment, the optical element is supported on support points. Preferably, three support points are provided, particularly preferably four support points. The support points are changeable in space, particularly preferably each independently of each other, and very preferably a translational change in space is possible. This also allows a displacement of the focal point of the beam of the laser source or light source in the beam direction or against the beam direction. Thus, the laser focus can also be changed in a third dimension, whereby the atom or the object can also be moved in the beam direction.

In a preferred embodiment, the optical element is an array of mirrors. Particularly preferably, the array consists of MEMS mirrors. In this way, multiple optical elements can be combined and their position can be changed rapidly and easily. In one embodiment, each MEMS mirror is supported on three or four support points so that movement both in the form of tilting or rotation and in the form of translational movement is possible.

In a preferred embodiment, the light source comprises multiple lasers, wherein also preferably the optical element is formed as an array of MEMS mirrors. Particularly preferably, the multiple lasers of the light source are configured and arranged such that one laser each is directed to a mirror or MEMS mirror of the array. This makes it possible to simultaneously form multiple focal points so that multiple objects and multiple atoms can be simultaneously displaced, influenced, moved and/or manipulated. It is also possible to let an atom remain in its position so that no further movement occurs, even if other forces from outside can act on the atom.

In a preferred embodiment, the array is formed from multiple MEMS mirrors on which the optical element is based. The individual MEMS mirrors are movable independently of each other. Preferably, they are simultaneously movable. In an alternative embodiment, the MEMS mirrors of the array are movable at different times, i.e., independently not only in spatial movement, but also in temporal movement of the individual mirrors. This allows building an array in which multiple mirrors can be controlled independently of each other.

In connection with the use of multiple laser sources, a device can thus be constructed in which multiple atoms or multiple objects can be moved or manipulated simultaneously and independently of each other in all spatial dimensions. When the light source comprises multiple lasers, this also includes that the light source has one laser and is split by an optical arrangement so that multiple directed laser beams or beams are generated. This can be done, for example, by an arrangement of multiple semi-transparent mirrors or by an array of microlenses. Alternatively, phase modulators (SLM) or 2D acousto-optical deflectors can also be used, which are operated with multiple frequencies simultaneously. In this way, a single laser can be used as a light source for several application requirements.

Such a device or a device as described above is suitable for use in a quantum computer. Thus, a quantum computer is formed that has one or more of the above-mentioned devices.

A quantum computer in which there are a device described above and a plurality of mirrors or an array of mirrors is preferred. For example, it is possible to act on all or only a part of the existing qubits of the quantum computer, such as on one or more registers or on one or more memory blocks.

Preferably, the number of mirrors is matched to the number of qubits to be manipulated in the quantum computer. In a further preferred embodiment, the number of mirrors is at least one hundredth to one tenth of the number of manipulating qubits. Further preferably, the number of mirrors corresponds to the number of manipulating qubits; very preferably, the number of qubits to be manipulated corresponds to a multiple of the mirrors of the array, particularly preferably to an integer multiple of the mirrors.

A quantum computer in which there are a device described above and a MEMS array, i.e., an array of multiple MEMS mirrors, is preferred. Preferably, the number of mirrors is greater than or equal to the number of qubits to be manipulated in the quantum computer. In a particularly preferred embodiment, the number of mirrors used in the array is designed such that the number of qubits to be manipulated in the quantum computer corresponds to an integer multiple of the mirrors or MEMS mirrors of the array. In this case, one mirror can manipulate multiple qubits, either simultaneously by splitting the beam path or temporally one after another by appropriate control.

The device described above can thus be used, for example, in a quantum computer. The field of neutral atom quantum computers is currently expanding very strongly. A device according to the invention or an optical tweezer based on the device according to the invention can be a module of such a neutral atom quantum computer. Due to the 3D mobility of the optical tweezers or the device, quantum algorithms can be implemented better and faster in a hardware-oriented manner.

Another use of the device is in material processing. For example, it is possible to simultaneously process material in three dimensions with multiple focused beams or laser beams. This considerably increases the processing speed compared to previously known methods or methods with a single beam. In particular, the use of the device according to the invention has the advantage that processing can also be performed in the third dimension. This is currently only enabled by changing the distance to the workpiece. For this purpose, the workpiece has to be moved to a new position. This is cumbersome, expensive, and imprecise. When using the device according to the invention, material can be selectively removed or material can be selectively locally changed in its properties.

Another possible use of the device is in the field of influencing microparticles or nanoparticles, preferably in biological samples. For example, such particles in biological samples can be better positioned relative to one another in three spatial dimensions and moved rapidly. This increases the variety of possible investigations, particularly with regard to dynamic aspects. Here there is a great application potential in research.

Above all, such uses can be made in confocal microscopes as optical tweezers so that the device can be part of a microscope. Such devices can be extended with the device according to the invention, which leads to manifold application possibilities in the field of microscopes. A microscope with a device according to the invention described above in one of the possible embodiments or in a combination of multiple optional design possibilities is also preferred.

It is also possible to use the device according to the invention as an optical tweezer. The device can also be part of an optical tweezer.

A system that comprises a plurality of optical tweezers, wherein the optical tweezers comprise a device as described above or are based on such a device, is preferred.

Within the scope of the invention, it has turned out that the technical implementation is difficult to move or manipulate atoms or objects simultaneously and independently of each other in the space. Only through the possibility of moving multiple optical tweezers simultaneously and independently of each other does the possibility arise for three-dimensional manipulation of atoms or objects that enables both transverse and translational movement. Within the scope of the invention, it was recognized that this can be done by an optical element that itself enables 3D movement, i.e., performs translational, rotational and/or tilting movements. Furthermore, it was recognized that this optical element has to lie outside a focal point when using divergent or convergent beams and that the deflected or redirected beam in the beam path behind the optical element is preferably influenced by an objective lens such that a focal point is formed. This focal point can be moved simultaneously in all three spatial directions by movement of the optical element, i.e., both transversely in the beam path direction or beam direction and in a plane perpendicular to the beam direction. This is understood to mean a plane whose normal vector is aligned parallel to the beam direction.

Only through simultaneous movement in all three spatial directions does a large field of application possibilities arise. This cannot be realized by coupling a translationally moved optical element with a transversely movable optical element. In particular, the movement of the focal point can be achieved independently of a movement of the atom or object to be manipulated. Only in this way is it possible to selectively change, influence, stabilize, or fix the position of the object or atom.

Many application possibilities open up through the parallelized use of multiple devices or optical tweezers according to the invention, which is possible now. The devices or tweezers work independently of each other.

### BRIEF DESCRIPTION OF THE DRAWINGS

The invention is described and explained in more detail below with reference to a few selected embodiments in connection with the accompanying drawings. They show:

FIG. 1 an optical device according to the invention for manipulating an atom or object;

FIG. 2 an extended device with a total of 2 beams for manipulating an atom;

FIG. 3 the extended device from FIG. 2 with a simplified beam path;

FIG. 4 an extended device with a total of 5 beams with a greatly simplified beam path;

FIG. 5 an optical element of the device according to the invention formed as an array; and

FIG. 6 the basic process flow of a method for manipulating an atom or object.

### DETAILED DESCRIPTION

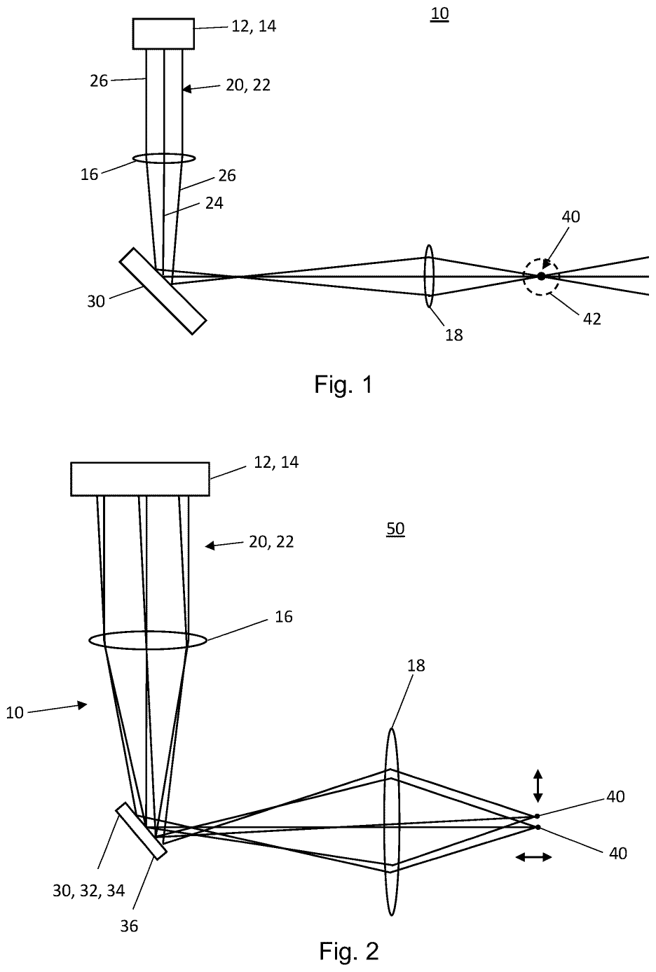

FIG. 1 shows a device 10 according to the invention for manipulating an atom or an object. The device 10 has a light source 12 for emitting a short-wave electromagnetic beam 20 as well as a movable optical element 30, which has three-dimensional mobility (3D mobility).

The light source 12 is preferably designed as a laser 14 or laser source that emits a laser beam 22. The beam 20 or laser beam 22 of the light source 12 or of the laser 14 is directed from the light source 12 to the optical element 30 and focused in a focal point 40 in the beam path thereafter.

The beam 20 is represented in FIG. 1 by a central beam axis 24 and two boundary axes 26, wherein the beam axis 24 represents the intensity maximum and the respective boundary axes 26 represent the “quasi-intensity minimum” of the beam 20. The “quasi-intensity minimum” typically has an intensity of 1/e² of the maximum intensity. The beam 20 is thus a beam distribution or intensity distribution in the figure shown here.

Between the light source 12 and the optical element 30, a lens 16 is arranged to convert the initially parallel beam 20 (boundary axes 26 are parallel) to a converging beam 20 so that the converging beam 20 strikes the optical element 30. The optical element 30 is arranged such that it does not lie at the focal point of the beam 20.

After deflection of the beam 20 at the reflecting optical element 30, the still converging beam 20 becomes a now diverging beam 20 after passing through an intermediate focus, which is converted back into a converging beam 20 by means of an objective lens 18 and focused at a focal point 40.

When the beam 20 strikes an atom or an object, a force or impulse directed toward the focal point 40 is exerted on the atom or object. For this purpose, the atom or object has to be arranged in an environment 42 around the focal point 40. The size of the environment 42 can depend on the application and use of the device 10 as well as on the beam 20 or laser beam 22 and its wavelength. Furthermore, the size of the environment 42, in which a desired effect on the atom or object is produced, can also depend on the atom or object, its size (extent) or mass.

The optical element 30 is designed as a mirror 32. The mirror 32 can be a MEMS mirror 34, which is preferred. The mirror 32 is preferably designed as a circular mirror and has a diameter that preferably lies between 0.5 mm and 1 mm. The stroke of the mirror 32, i.e., the mobility in transverse direction or in the direction of the surfaces of the mirror 32, preferably lies between 0.05 mm and 2 mm, more preferably between 0.05 mm and 1 mm, particularly preferably between 0.1 Mm and 0.25 Mm.

The lens 16 as well as the objective lens 18 typically have a preferred diameter of 15 mm to 70 mm; particularly preferably the diameter lies between 20 mm and 50 mm. The beam 20, which can be designed as a laser beam 22 or as a laser beam bundle, has a diameter that is approximately 30 mm to 40 mm, preferably it lies between 25 mm and 50 mm. Overall, the path length of the beam 20 from the light source 12 to the focal point 40 is approximately 1 m to 2 m, preferably the path length is between 50 mm and 600 mm, particularly preferably between 100 mm and 200 mm. The length, the distance in the beam path between the light source 20 and the focal point 40, can vary depending on the type of application and field of use or application and can certainly be larger or smaller.

FIG. 2 shows a system 50 with two optical tweezers that are based on the device 10. The two beams 20 strike different areas of the optical element 30 so that, after passage through the objective lens 18, two focal points 40 arranged next to each other are formed. The focal points 40 are movable and changeable independently of each other, at least when the optical element 30 is formed by multiple mirrors 32 or an array 36 with multiple mirrors 32 or multiple MEMS mirrors 34. The individual mirrors 32 can be moved independently of each other.

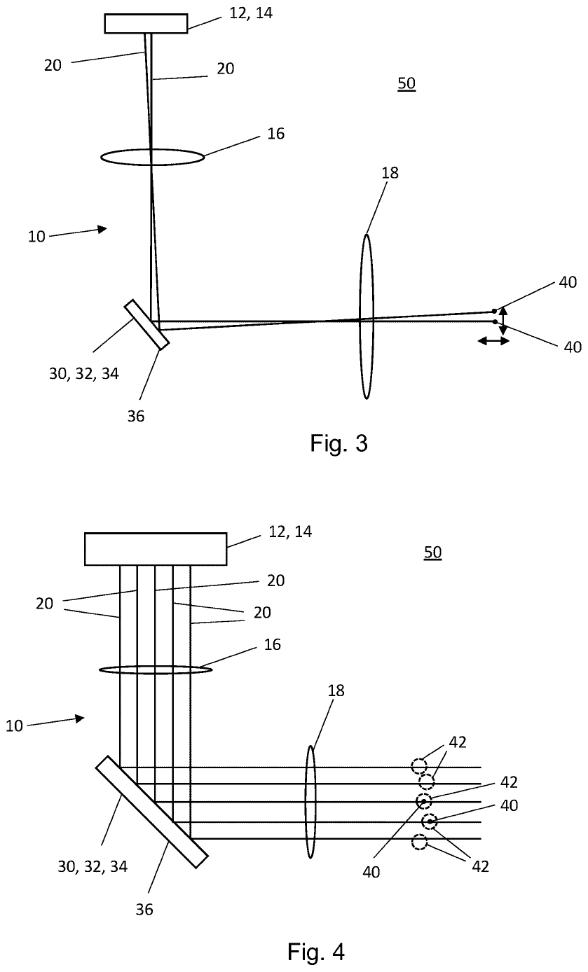

FIG. 3 shows the embodiment according to FIG. 2. However, for better viewing, the beams 20 are represented only by a single beam. Since all beams 20 pass through the center of the lens 16 and strike different mirrors 32 of the optical element 30, the desired two focal points 40 are formed, which are movable independently of each other, namely in transverse direction and in lateral direction or in a plane perpendicular to the transverse direction.

FIG. 4 shows a system 50 with multiple optical tweezers that are based on the device 10. A light source 12 emits multiple beams 20, of which only the beam axis 24 is shown in each case. These beams 20 correspond to the beams 20 from FIG. 1 or FIG. 2 and are convergent or divergent when striking the optical element 30. After deflection at the optical element 30, they are each focused at a focal point 40 by means of multiple objective lenses 18. In FIG. 4, for reasons of clarity, only the respective environment 42 of a focal point 40 as well as one objective lens 18 and one lens 16 are shown instead of a plurality (here five) of objective lenses or lenses arranged in parallel. Thus, a separate lens 16 and/or objective lens 18 is provided for each beam 20.

For better understanding and for reasons of clarity, the beams 20 are shown here running parallel. Since the beams 20 are guided through different areas of the lens 16, they can run essentially next to each other or parallel. It is also possible here to direct the beams 20 through the center or a common point or area of the lens 16, whereby they can then cross.

Alternatively, the light source 12 can comprise multiple light sources 12 or multiple lasers 14, each of which generates a beam 20 or a beam bundle of laser beams 22. The beams 20 of a beam bundle can be collimated. However, the individual beams 20 are also divergent or convergent and are focused at the focal point 40. Here it is important that they strike the optical element 30 as convergent or divergent beams 20.

Exactly as with the device 10 from FIG. 1, a lens 16 is arranged between the light source 12 and the optical element 30 to shape the respective beam 20 accordingly in a predefined manner. The beams 20 are each shaped such that they are convergent or divergent when striking the optical element 30. The optical element 30 lies outside a focus of the beam 20 or the beams 20. Alternatively, the lens 16 can be formed by multiple lenses 16 so that a single lens 16 is provided for each beam 20.

In the beam path behind the optical element 30, an objective lens 18 is arranged to focus the beams 20 each at a focal point 40. Of course, the objective lens 18 can be part of an objective or be replaced by an objective. Additional optical components can also be introduced into the beam path, particularly after the optical element 30.

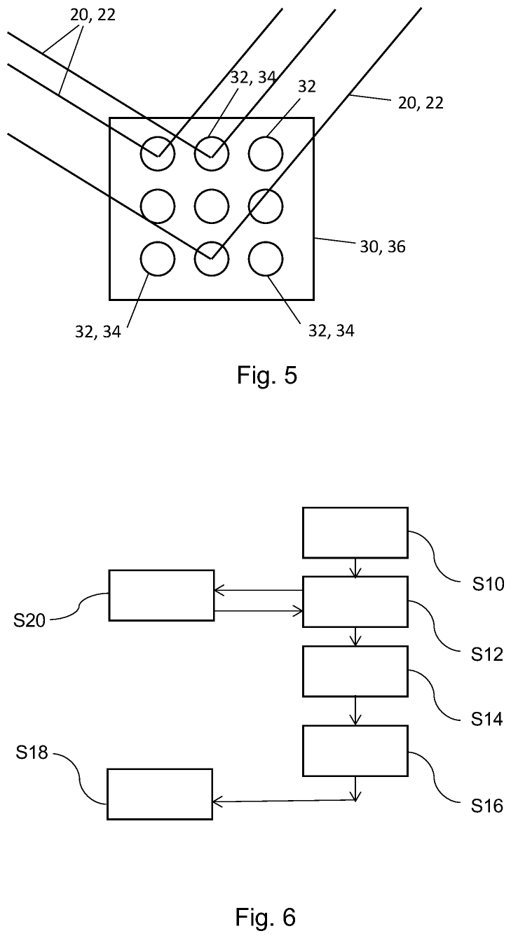

The optical element 30 is preferably an array 36 of multiple mirrors 32 or multiple MEMS mirrors 34. The individual mirrors 32 can be arranged next to each other in rows and columns, for example (FIG. 5). The individual mirrors 32 can be moved and adjusted independently of each other so that for each beam 20 a separate focal point 40 and a corresponding environment 42 are formed, which are independent of each other and different in their location and position from each other, also relative to the other beams 20. In this way, it is possible to manipulate multiple atoms or objects simultaneously and independently of each other, i.e., to move, shift, hold or fix them.

An optical element 30 designed as an array 36 is shown in detail in FIG. 5. In the embodiment shown here, the array 36 has nine mirrors 32, which are designed as MEMS mirrors 34 and are arranged in the form of a 3×3 matrix. The mirrors 32 or MEMS mirrors 34 are supported at multiple support points, preferably at four support points so that a change in position of the mirrors 32 or MEMS mirrors 34 is possible.

The individual beams 20 strike the mirror 32 assigned to them, respectively, and are reflected by this mirror 32. By changing the position of the mirror 32, i.e., by tilting or raising and lowering it around a predetermined stroke, a displacement and change of the focal point 40 in the beam path occurs. In this way, a force or impulse can be exerted on atoms or objects arranged in the environment 42 of the focal point 40 to influence or manipulate their position.

FIG. 6 shows a schematic representation of the process flow for manipulating an object or an atom, which comprises multiple steps.

In a first step S10, short-wave electromagnetic radiation is emitted by a light source 12. The light source 12 is, for example, a laser 14 that emits a laser beam 22. Optionally, beam shaping can additionally be performed, for example by means of a lens 16.

In a step S12, the emitted beam 20 is influenced by means of an optical element 30. Here, the optical beam 20 is deflected. The optical element 30 is thus designed to be reflective and reflects the incident beam 20.

In a further step S14, the incident beam 20 is forwarded by means of the optical element 30 in such a way that the beam 20 is focused at a focal point 40 in the beam path after the optical element 30. Optionally, in a further step, beam shaping can be performed between the optical element 30 and the focal point 40 by means of an objective lens 18 or an objective.

A step S16 provides for three-dimensional movement of the optical element 30 such that the focal point 40 is displaceable and is displaced. In this way, manipulation of an atom or object is achieved that is arranged in the environment 42 around the respective focal point 40. The atom or object located in the environment 42 can thus be displaced or fixed. This effect is shown in FIG. 4 as step S18, which comprises manipulating the atom or object in the environment 42.

In an optional step S20, the 3D mobility of the optical element 30 is achieved by performing a translational movement or tilting of the respective optical element 30. This preferably occurs from a position in which the normal vector of the optical element 30 is aligned parallel to the translational movement. Thus, translational movement or lifting of the optical element 30 occurs along its normal vector, which is aligned parallel to the beam path. After tilting the optical element 30, the normal vector of the optical element 30 has an angle greater than 0° to the translational movement. When the optical element 30 is constructed from multiple mirrors 32, for example in an array 36, the 3D mobility according to step S20 occurs for each of the individual mirrors 32 independently of each other.

The invention has been comprehensively described and explained with reference to the drawings and the description. The description and explanation are to be understood as examples and not as limiting. The invention is not limited to the disclosed embodiments. Other embodiments or variations will be apparent to those skilled in the art when using the present invention and upon careful analysis of the drawings, the disclosure and the following patent claims.

In the patent claims, the words “comprise” and “with” do not exclude the presence of further elements or steps. The indefinite article “a” or “an” does not exclude the presence of a plurality. A single element or a single unit can perform the functions of several of the units mentioned in the patent claims. An element, a unit, a device and a system can be implemented partially or completely in hardware and/or in software. The mere mention of some measures in several different dependent patent claims is not to be understood as meaning that a combination of these measures cannot also be used advantageously. Reference signs in the patent claims are not to be understood as limiting.

### LIST OF REFERENCE SIGNS

10 Device
12 Light source
14 Laser
16 Lens
18 Objective lens
20 Beam
22 Laser beam
24 Beam axis
26 Boundary axis
30 Optical element
32 Mirror
34 MEMS mirror
36 Array
40 Focal point
42 Environment
50 System

1-21. (canceled)

22. An optical device for manipulating an atom or an object comprising:
a light source for emitting a short-wave electromagnetic beam; and
a movable optical element for influencing the short-wave electromagnetic beam;
wherein the movable optical element has 3D mobility;
the short-wave electromagnetic beam of the light source is directed to the movable optical element and is focused at a focal point in a beam path thereafter; and
the movable optical element is arranged and configured such that by a movement of the movable optical element the focal point is displaceable and a spatial manipulation of the atom or object is caused in an environment around the focal point.

23. The optical device according to claim 22, wherein an objective lens is arranged in the beam path between the movable optical element and the focal point and/or a lens is arranged in the beam path between the light source and the movable optical element.

24. The optical device according to claim 22, wherein the focal point lies within a spatial extent of the atom or the object.

25. The optical device according to claim 22, wherein the light source is a laser and the short-wave electromagnetic beam is a laser beam, wherein the laser beam has a wavelength between 200 nanometers and 11 micrometers.

26. The optical device according to claim 25, wherein the laser beam has a wavelength between 270 nanometers and 1100 nanometers.

27. The optical device according to claim 22, wherein the 3D mobility of the movable optical element is provided in all spatial directions such that the atom or object is movable in all spatial directions, wherein movement in individual spatial directions can occur separately and independently of each other.

28. The optical device according to claim 22, wherein the 3D mobility of the movable optical element is provided in all spatial directions such that the atom or object is movable at least in a beam direction of the short-wave electromagnetic beam.

29. The optical device according to claim 22, wherein the light source generates a laser beam that is divergent or convergent or that is focused or defocused.

30. The optical device according to claim 29, wherein the movable optical element is arranged in a region in the beam path where the beam is divergent or convergent in a defocused region of the beam.

31. The optical device according to claim 22, wherein the movable optical element is a mirror or a MEMS mirror.

32. The optical device according to claim 22, wherein the movable optical element has at least three support points.

33. The optical device according to claim 32, wherein the support points are changeable in space.

34. The optical device according to claim 32, wherein the support points are changeable in space, each independently of each other.

35. The optical device according to claim 32, wherein the support points are changeable translationally and/or rotationally in space.

36. The optical device according to claim 22, wherein the movable optical element is an array of mirrors.

37. The optical device according to claim 36, wherein the light source comprises multiple lasers, wherein one laser each is directed to a mirror of the array.

38. The optical device according to claim 36, wherein the mirrors of the array are movable independently of each other.

39. The optical device according to claim 36, wherein the mirrors of the array are movable simultaneously or at different times.

40. A quantum computer with a device according to claim 22.

41. The quantum computer according to claim 40 and with an array of mirrors, wherein the number of mirrors is matched to the number of manipulating qubits.

42. The quantum computer according to claim 41, wherein the number of mirrors is at least one hundredth to one tenth of the number of manipulating qubits.

43. The quantum computer according to claim 41, wherein the number of mirrors corresponds to the number of manipulating qubits.

44. The quantum computer according to claim 41, wherein the number of qubits to be manipulated corresponds to an integer multiple of the mirrors of the array.

45. The quantum computer according to claim 40 that functions on a basis of neutral atoms.

46. A material processing unit with a device of claim 22, the material processing unit configured to selectively remove material or to locally change properties in a material.

47. An influencing unit with a device of claim 22, the influencing unit configured to position and move microparticles or nanoparticles relative to one another in three spatial directions.

48. An optical tweezer with a device according to claim 22.

49. A system comprising a plurality of optical tweezers, wherein the optical tweezers are based on a device according to claim 22.

50. A method for manipulating an atom or an object comprising:
providing a device according to claim 22;
emitting a short-wave electromagnetic beam via a light source;
influencing an emitted beam by means of an optical element;
forwarding an incident beam by means of the optical element such that the short-wave electromagnetic beam is focused at a focal point in a beam path after the optical element; and
three-dimensionally moving the optical element such that the focal point is displaceable and is displaced, to cause manipulation of the atom or object in an environment around the focal point, in particular to displace the atom or object.

51. The method according to claim 50, wherein the optical element has 3D mobility and can be moved translationally and/or tilted from a position in which a normal vector of the optical element is aligned parallel to a translational movement such that the normal vector assumes an angle greater than 0° to the translational movement after tilting the optical element.
